(19) United States
(12) Patent Application Publication
(10) Pub. No.: US 2026/0042977 A1
(43) Pub. Date: Feb. 12, 2026

(54) COMPOSITIONS, THEIR MANUFACTURE AND USE

(71) Applicant: BASF SE, Ludwigshafen Am Rhein (DE)

(72) Inventors: Stephan HUEFFER, Ludwigshafen am Rhein (DE); Heike WEBER, Ludwigshafen am Rhein (DE); Swati DE, Ludwigshafen am Rhein (DE)

(21) Appl. No.: 18/846,068

(22) PCT Filed: Mar. 27, 2023
(86) PCT No.: PCT/EP23/57759

§ 371 Date: Sep. 11, 2024

(30) Foreign Application Priority Data
Apr. 14, 2022 (EP) 22168419.4

(51) Int. Cl. C11D 3/30; C11D 3/20; C11D 3/37; C11D 3/386

(52) U.S. Cl. CPC C11D 3/30; C11D 3/2086; C11D 3/3715; C11D 3/38636

(57) ABSTRACT

Disclosed herein is a composition including
(A) at least one combination of compounds including
   (α) triethanolamine, and
   (β) citrate,
   and
(B) at least one water-soluble polymer that bears at least two ester groups per molecule.

### CROSS-REFERENCE TO RELATED APPLICATIONS

This application is a U.S. National Phase Application of International Patent Application No. PCT/EP23/57759, filed Mar. 27, 2023, which claims priority to European Patent Application No. 22168419.4, filed Apr. 14, 2022, each of which is hereby incorporated by reference herein.

### REFERENCE TO AN ELECTRONIC SEQUENCE LISTING

The contents of the electronic sequence listing (sequence_listing_27843-2580.xml; Size: 6.4 KB; and Date of Creation: Apr. 2, 2025) are herein incorporated by reference in their entirety.

The present invention is directed towards liquid laundry compositions comprising
(A) at least one combination of compounds comprising
   (α) triethanolamine,
   (β) citrate,
   and
(B) at least one water-soluble polymer that bears at least two ester groups per molecule.

In addition, the present invention relates to the use of combinations of compound (α) and compound (β) in laundry detergents.

Laundry detergents have to fulfil several requirements. They need to remove all sorts of soiling from laundry, for example all sorts of pigments, clay, fatty soil, and dyestuffs including dyestuff from food and drinks such as red wine, tea, coffee, and fruit including berry juices. Laundry detergents also need to exhibit a certain storage stability. Especially laundry detergents that are liquid or that contain hygroscopic ingredients often lack a good storage stability, e.g., enzymes tend to be deactivated.

A modern requirement of detergent compositions is that the amount of non-biodegradable components is reduced. It is therefore suggested to replace certain effect polymers by biodegradable polymers. However, it has been observed that biodegradable polymers may undergo degradation already before they reach the end user and their beneficial effects during cleaning—laundry or dishware—are greatly reduced.

It was therefore an objective of the instant invention to provide a composition that contains an enzyme or a biodegradable polymer and that overcomes the above shortcomings and that has a good shelf life. It was furthermore an objective to provide a method to improve performance and shelf life of detergent compositions, and it was an objective to provide a process for making such compositions.

In US 2014/0174480, specific formulations for hard surface cleaning are disclosed that contain neither enzymes nor biodegradable polymers.

Accordingly, the liquid laundry compositions as defined at the outset were found, hereinafter also defined as inventive compositions or as compositions according to the present invention. Inventive compositions comprise components (A), (B) and (C) as defined below:
(A) least one combination of compounds comprising
(α) triethanolamine,
(β) citrate,
   and
(B) at least one water-soluble polymer that bears at least two ester groups per molecule.

Components (A), (B) and (C) are now described in more detail.

### Compound (α) Comprises Triethanolamine.

In one embodiment of the present invention, inventive combinations (A) additionally comprise (γ) an aliphatic or cycloaliphatic amine that has a boiling temperature at ambient pressure of 180° C. or more, for example 180 to 300° C., and that does not bear N—CH₂CH(X¹)—OH groups. Examples of aliphatic or cycloaliphatic amine (γ), hereinafter also referred to as compound (γ), are methyldiaminocyclohexane, and N,N-bis(β-aminopropyl)-1,2-ethanediamine. In the context of aliphatic or cycloaliphatic amine (γ), diamines, triamines and tetramines are included in the term “amine”.

In one embodiment of the present invention, the molar ratio of compound (α) and compound (γ) is in the range of from 20:1 to 1:3.

In addition, inventive compositions contain at least one
(β) citrate.

Citrate may bear free carboxylic acid groups or be neutralized, for example with at least one carboxyl group per molecule of citrate being present as ammonium salt, ammonium being selected from alkylammonium and alkanolammonium.

Preferred is citrate (β) that does not bear alkali metal as counterion such as sodium of any of its carboxyl groups.

In one embodiment of the present invention, the sodium content of citrate (β) is 0.5 to 1.5% by weight or less, preferably 1% by weight or less, referring to the entire composition.

Some amines have an unpleasant odour. It is thus preferred that ammonium ions are selected that are derived—by protonation—from amines with a low volatility, for example a boiling point at ambient pressure of higher than 180° C. Preference is given as well to ammonium ions that are derived from amines that do not have an unpleasant odour.

Counterions like triethanolammonium, N,N-diethanolammonium, N-methyl-N,N-diethanolammonium, N,N-dimethyl-ethanolammonium, and ethanolammonium, are preferred, more preferred is triethanolammonium.

In one embodiment of the present invention, the molar ratio of amino groups in compound (α) to carboxylate groups from compound (β) is in the range of from 1:10 to 10:1, preferably from 5:3 to 2:3. The molar ratio refers to total mol of N—CH₂—CH(X¹)—OH group(s) versus total carboxyl groups stemming from citrate. Thus, if, e.g., 0.3 mole citrate per litre detergent composition are employed and 0.5 mole of triethanolamine, then the molar ratio of N—CH₂—CH(X¹)—OH groups in compound (α) to carboxylate groups from compound (β) is 1:0.9.
(β) Inventive detergent compositions furthermore comprise at least one water-soluble polymer that bears at least two ester groups per molecule, such polymers also being referred to as polymers (β).

Ester groups are selected from carboxylic esters and (organic) carbonates.

In the context of the present invention, polymer (B) is deemed water-soluble if at least 50 g of such polymer are soluble in a litre of distilled water at 20° C. and form a clear solution or stable dispersion that appears transparent for the unaided eye.

In one embodiment, inventive detergent compositions comprise both a hydrolase (C) and a one water-soluble polymer that bears at least two ester groups per molecule (B).

Inventive detergent compositions comprise at least one water-soluble polymer that bears at least two ester groups per molecule, hereinafter also referred to as polymer (B). Ester groups may be selected from carboxylic esters and carbonates.

In the context of the present invention, polymers are defined as organic molecules with an average molecular weight Mₙ in the range of from 1,000 to 50,000 g/mol, preferably 3,000 to 30,000 g/mol. Suitable ways to determine the average molecular weight Mn is gel permeation chromatography (“GPC”). As mobile phase, aqueous media are feasible, for example 0.1 M aqueous NaCl solution containing 0.1% by weight trifluoric acid as mobile phase, or fluorinated alcohols such as hexafluoroisopropanol (“HFIP”). An example of a suitable stationary phase is TSKgel.

In one embodiment of the present invention, polymer (B) has an average molecular weight M_{w} in the range of from 2,500 to 100,000 g/mol, preferably 3,400 to 25,000 g/mol. The average molecular weight may be determined, e.g., by gel permeation chromatography (GPC) in 0.1 M aqueous NaCl solution containing 0.1% by weight trifluoric acid as mobile phase, or in hexafluoroisoropanol (“HFIP”), each time preferably with TSKgel as standard

In one embodiment of the present invention, polymer (B) has a molecular weight distribution M_{w}/Mₙ in the range of from 1.1 to 6.0.

In one embodiment of the present invention, polymer (B) is selected from
(B1) polymers comprising
   (α) at least one backbone that bears one to forty β-aminoalcohol groups or β-amino(alkylenoxide) groups
   (b) wherein some β-aminoalcohol groups or β-amino-(alkylenoxide) groups are esterified with a mono- or diacid of a polyalkylene oxide wherein at least 50 mol-% of the alkylene oxide groups are ethylene oxide groups, or with the monomethyl ether of a monoacid of a polyalkylene oxide of which at least 50 mol-% of the alkylene oxide groups are ethylene oxide groups, and, optionally,
   (c) wherein some β-aminoalcohol groups or β-amino-(alkylenoxide) groups are esterified with aliphatic C₄-C₁₀-di- or tricarboxylic acid, for example adipic acid, sebacic acid, citric acid or a combination of at least two of the afore mentioned.

Backbone (a) bears one forty β-aminoalcohol groups or β-amino-(alkylenoxide) groups.

The term β-aminoalcohol groups refers to —N—CH(R^{a})—CH₂—O-groups with R^{a} being selected from methyl and especially hydrogen. Specific examples are N—CH₂CH₂OH-groups, N—(CH₂CH₂)₂OH-groups, N—CH₂CH(CH₃)OH-groups and N—(CH₂CH(CH₃))₂OH-groups, and combinations of at least two of the aforementioned. In polymer (C1) and after esterification, the hydrogen on the OH group is replaced by a carboxyl group.

The term β-amino-(alkylenoxide) groups refers to —N(AO)ₓ-groups and to —N[(AO)ₓ]₂-groups, with AO being a variable selected from ethylene oxide (EO) and propylene oxide (PO) and combinations, and x being in the range of from 2 to 10. In embodiments wherein AO refers to combinations of EO and PO, they are usually arranged block-wise rather than statistically. Preferably, at least half of all AO is EO. More preferably, all AO are EO.

In one embodiment of the present invention, backbone (a) is selected from alkoxylated triethanolamine, alkoxylated N,N′-bis-(3-aminopropyl)-ethylenediamine, alkoxylated polyethylenimine, alkoxylated N,N-bis(2-aminoethyl)-1,2-ethanediamine 1,1-bis(2-hydroxyethyl)-ethanolamine and alkoxylated compounds of methyldiaminocyclohexane (MCDA).

In alkoxylated triethanolamine, alkoxylated N,N′-bis-(3-aminopropyl)-ethylenediamine, alkoxylated polyethylenimine, alkoxylated N,N-bis(2-aminoethyl)-1,2-ethanediamine 1,1-bis(2-hydroxyethyl)-ethanolamine and alkoxylated compounds of methyldiaminocyclohexane (“MCDA”), alkoxylation may, for example, be selected from propoxylation, butoxylation and ethoxylation, preference being given to ethoxylation and combinations of ethoxylation and propoxylation, even more preferred is ethoxylation, thus, without either of propoxylation and butoxylation. In embodiments wherein combinations of ethoxylation and propoxylations are provided, the ethylene oxide units and propylene oxide units are arranged blockwise rather than randomly.

The term “polyethylenimine” in the context of the present invention does not only refer to polyethylenimine homopolymers but also to polyalkylenimines containing NH—CH₂—CH₂—NH structural elements together with other alkylene diamine structural elements, for example NH—CH₂—CH₂—CH₂—NH structural elements, NH—CH₂—CH(CH₃)—NH structural elements, NH—(CH₂)₄—NH structural elements, NH—(CH₂)₆—NH structural elements or (NH—(CH₂)₈—NH structural elements but the NH—CH₂—CH₂—NH structural elements being in the majority with respect to the molar share. Preferred polyethylenimines contain NH—CH₂—CH₂—NH structural elements being in the majority with respect to the molar share, for example amounting to 60 mol-% or more, more preferably amounting to at least 70 mol-%, referring to all alkyleneimine structural elements. In a special embodiment, the term polyethylenimine refers to those polyalkylenimines that bear only one or zero alkyleneimine structural element per molecule that is different from NH—CH₂—CH₂—NH.

In one embodiment of the present invention, the average molecular weight M_{w} of polyethylenimines before alkoxylation is in the range of from 500 to 100,000 g/mol, preferably up to 50,000 g/mol and more preferably from 800 up to 25,000 g/mol. The average molecular weight M_{w} of polyethylenimines may be determined by gel permeation chromatography (GPC), with 1.5% by weight aqueous formic acid as eluent and cross-linked poly-hydroxyethyl methacrylate as stationary phase.

In one embodiment of the present invention, polyalkylenimines before alkoxylation display a polydispersity Q=M_{w}/Mₙ of at least 3.5, preferably in the range of from 3.5 to 10, more preferably in the range of from 4 to 9 and even more preferably from 4.0 to 5.5. In other embodiments of the present invention, polyalkylenimines display a polydispersity Q=M_{w}/Mₙ of 3.4 at most, for examples in the range of from 1.1 to 3.0, more preferably in the range of from 1.3 to 2.5 and even more preferably from 1.5 to 2.0.

Polyethylenimines before alkoxylation may have a linear or branched structure. Branches may be alkyleneamino groups such as, but not limited to —CH₂—CH₂—NH₂ groups or (CH₂)₃—NH₂-groups. Longer branches may be, for examples, —(CH₂)₃—N(CH₂CH₂CH₂NH₂)₂ or —(CH₂)₂—N(CH₂CH₂NH₂)₂ groups. Highly branched polyethylenimines are, e.g., polyethylenimine dendrimers or related molecules with a degree of branching in the range from 0.25 to 0.95, preferably in the range from 0.30 to 0.80 and particularly preferably at least 0.5. The degree of branching can be determined for example by ¹³C-NMR or ¹⁵N-NMR spectroscopy, preferably in D₂O, and is defined as follows:

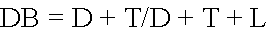

with D (dendritic) corresponding to the fraction of tertiary amino groups, L (linear) corresponding to the fraction of secondary amino groups and T (terminal) corresponding to the fraction of primary amino groups.

Within the context of the present invention, branched polyethylenimines are polyethylenimines with DB in the range from 0.25 to 0.95, particularly preferably in the range from 0.30 to 0.90% and very particularly preferably at least 0.5. Such branched polyethylenimines may be made by polymerization of aziridine.

In the context of the present invention, CH₃-groups are not being considered as branches.

Preferred polyethylenimines are those that exhibit little or no branching, thus predominantly linear or linear polyethylenimine backbones. In another embodiment, preferred polyethylenimines are branched polyethylenimines. If as block (a) a backbone based on di-ethoxylated MCDA is provided, usually a mixture of compounds as shown above is provided.

Polymer (C1) may contain one or more backbones (a) that have different or preferably the same structure and that may be connected to each other through a block (b) or (c).

In one embodiment of the present invention, polymer (C1) has 1 to 15 backbones (a) per molecule, preferably 3 to 7.

In polymer (C1), some of the hydroxyl groups of β-aminoalcohol groups or β-amino(alkylenoxide) groups are esterified with a mono- or diacid of a polyalkylene oxide of which at least 50 mol-% of the alkylene oxide groups are ethylene oxide groups, block (b).

In block (b), the alkylene oxide groups that are not ethylene oxide are preferably selected from propylene oxide, especially 1,2-propylene oxide (“PO”), and butylene oxide, especially 1,2-butylene oxide (“BuO”). Preferred alkylene oxide other than ethylene oxide is PO.

Preferred mono- and diacids of polyalkylene oxide and preferred monomethyl ethers of a monoacid of a polyalkylene oxide are compounds according to general formula (I)

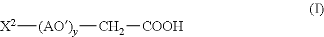

wherein
X² is HO—CH₂—CH₂—O— or CH₃—O—CH₂—CH₂—O— or HO₂C—CH₂—O—,
AO′ is selected from ethylene oxide (EO), CH₂—CH₂—O, and combinations of EO and propylene oxide (PO) or butylene oxide (BuO) with at least 50 mol-% of all AO′ being EO. In embodiments where AO′ refers to combinations of EO and PO or BuO, they are usually arranged block-wise rather than statistically. More preferably, all AO′ are EO, and
y is in the range of from 2 to 20, preferably 4 to 15. The variable y may be an average value and then refers to the number average.

In a preferred embodiment of the present invention, diacids according to formula (I) contain the respective monoacid as an impurity, for example up to 15 mol-%, preferably 1 to 12 mol-%.

In a preferred embodiment of the present invention, mono-acids according to formula (II) contain both the respective diacid and the non-oxidized diol as impurities, for example 50 mol-% in total.

In polymer (C1), some of the hydroxyl groups of the β-aminoalcohol groups or β-amino(alkylenoxide) groups of backbone (a) may be esterified with
(c) aliphatic C₄-C₁₀-di- or tricarboxylic acid.

Examples of suitable aliphatic C₄-C₁₀-dicarboxylic acids are succinic acid, glutaric acid, adipic acid, suberic acid, pimelic acid, azelaic acid and sebacic acid. Aliphatic C₄-C₁₀-dicarboxylic acids may bear functional groups other than carboxyl groups, for example alcohol groups. Examples of suitable aliphatic C₄-C₁₀-dicarboxylic acids that bear functional groups other than carboxyl groups are tartaric acid, malic acid

Of the aliphatic C₄-C₁₀-tricarboxylic acids, C₆-C₈-tricarboxylic acids are preferred. Examples of suitable aliphatic C₄-C₁₀-tricarboxylic acids are propane-1,2,3-tricarboxylic acid. Aliphatic C₄-C₁₀-tricarboxylic acids may bear functional groups other than carboxyl groups, for example alcohol groups. Examples of suitable aliphatic C₄-C₁₀-tricarboxylic acids that bear functional groups other than carboxyl groups are citric acid and isocitric acid and oxalosuccinic acid. Citric acid is particularly preferred as C₆-C₈-tricarboxylic acid.

In one embodiment of the present invention, some of the hydroxyl groups are esterified with only one aliphatic C₄-C₁₀-dicarboxylic acid. In other embodiments, some of the hydroxyl groups are esterified with a mixture of aliphatic C₄-C₁₀-dicarboxylic acid and aliphatic C₄-C₁₀-tricarboxylic acid, for example with a combination of adipic acid and citric acid or a combination of sebacic acid and citric acid or with a combination of adipic acid with sebacic acid and citric acid.

In a preferred embodiment, at least one block (c) per molecule of polymer (C1) is esterified with of the hydroxyl groups of the β-aminoalcohol groups or β-amino-(alkylenoxide) groups of two different backbones (a), for example one to five blocks (c).

In one embodiment of the present invention, the molar ratio of block (b) to block (c) is in the range of from 1:25 to 5:1, for example from 1:10 to 1:5.

In one embodiment of the present invention, all carboxylic groups of block(s) (c) are esterified. It is preferred, though, that some carboxylate groups remain as free acids.

In one embodiment of the present invention, polymer (B) is selected from polymers (B2), alkoxylated and preferably polyethoxylated polyaspartate esters. Despite the name such polyesters are not synthesized from aspartic acid but preferably from unsaturated polyesters (UPE) and primary amines using the Aza-Michael addition. The product of this reaction contains a polyester backbone with side chains connected to the backbone through secondary amino groups.

In one embodiment of the present invention, polymer (B) is selected from polymers (B3). Polymers (B3) have an average molecular weight M_{w} of at least 1,500 g/mol that comprises certain repeating units:

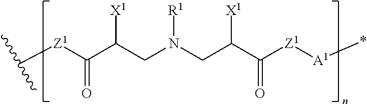

wherein
X¹ are different or preferably same and selected from hydrogen and methyl, preferably all Z¹ are the same and hydrogen.
R¹ are same or different and selected from C₂-C₄-alkyl, for example methyl, ethyl, n-propyl, isopropyl, n-butyl, isobutyl, sec.-butyl, or tert.-butyl, preferably CH₃ or C₂H₅, non-substituted or substituted with hydroxy or —NR^{2a}R^{2b},
R^{2a} and R^{2b} are different or preferably same and selected from C₁-C₄-alkyl, C₁-C₄-alkyl being defined as above, or NR^{2a}R^{2b} together form a C₅-C₆-cycloalkylenamino or 1-imidazole group. Preferred examples of —NR^{2a}R^{2b} are —N(CH₃)₂, —N(C₂H₅)₂, —N(CH₂)₄, and —N(CH₂)₅.

The variable n is selected from 3 to 100, preferably 3 to 45.
Z¹ is selected from O and N—R³, with R³ being selected from hydrogen and methyl, preferably all Z¹ are oxygen,
A¹ are same or different and selected from C₂-C₆-alkylene such as —(CH₂)₂—, —(CH₂)₃—, —(CH₂)₄—, —(CH₂)₅—, —(CH₂)₆—, and preferably from (AO)_{y1}, with AO being selected from ethylene oxide (“EO”) and propylene oxide (“PO”) and combinations thereof, and y1 being from 2 to 200, preferably 2 to 10.

In embodiments wherein (AO)_{y1} refers to combinations from EO and PO, such EO and PO may be arranged randomly or preferably block-wise, in two or three blocks. In preferred embodiments wherein (AO)_{y1} refers to combinations from EO and PO, at least 50 mol-% of AO are EO, for example 50 to 90 mole-%, more preferably 65 to 90 mol-%.

Even more preferably, all AO in (AO)_{y1} and thus in A¹ are EO.

The repeating units are connected to each other through the asterisk * that symbolizes the link to another repeating unit or to an end capping group, e.g., according to general formula:

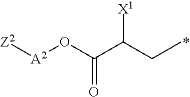

per molecule, preferably up to two per molecule.

In formula (II), A² is selected from (AO)_{y2}, with AO being selected from ethylene oxide and propylene oxide and combinations thereof, and y2 being from 2 to 200, preferably 2 to 45,
and Z² is selected from
hydrogen,
C₁-C₁₀-alkyl groups, for example methyl, ethyl, n-propyl, isopropyl, n-butyl, isobutyl, sec.-butyl, tert.-butyl, n-pentyl, iso-amyl, n-hexyl, isohexyl, n-heptyl, isoheptyl, n-octyl, n-nonyl, or n-decyl, preferably CH₃ or C₂H₅
the carboxylate of an aliphatic C₂-C₂₀-alkyl fatty acid, for example capric acid, lauric acid, myristic acid, palmitic acid, stearic acid or arachidic acid; or of a C₁₀-C₂₀-alkenyl fatty acid, for example oleic acid, palmitoleic acid, linoleic acid, linoelaidic acid, and α-linolenic acid, preferred are oleic acid, lauric acid, palmitic acid and stearic acid.
A² are same or different and selected from (AO)_{y2}, with AO being selected from ethylene oxide (“EO”) and propylene oxide (“PO”) and combinations thereof, and y2 being from 2 to 200, preferably from 2 to 45.

In embodiments wherein (AO)_{y2} refers to combinations from EO and PO, such EO and PO may be arranged randomly or preferably block-wise, in two or three blocks. In preferred embodiments wherein (AO)_{y2} refers to combinations from EO and PO, at least 50 mol-% of AO are EO, for example 50 to 90 mole-%, more preferably 65 to 90 mol-%.

Even more preferably, all AO in (AO)_{y2} and thus in A² are EO.

Preferably, A¹ and A² are identical.

In the above formula, the asterisk denotes the part that is linked to an N-atom of polymer (B3).

In one embodiment of the present invention, polymer (B3) bears at least one group of general below formula per molecule

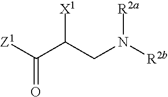

R^{2a} and R^{2b} are different or preferably same and selected from C₁-C₄-alkyl, C₁-C₄-alkyl being defined as above, or NR^{2a}R^{2b} together form a C₅-C₆-cycloalkylenamino or 1-imidazole group. Preferred examples of —NR^{2a}R^{2b} are 1-imidazole, —N(CH₃)₂, —N(C₂H₅)₂, —N(CH₂)₄, and —N(CH₂)₅.

The other variables are defined as above.

In one embodiment of the present invention, polymers are selected from polymer (B4). Polymers (B4) have
(d) a core that bears one to 3 moieties of the general formula (I),

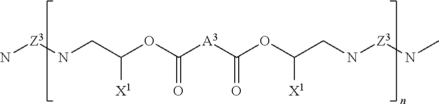

wherein the variables are defined as follows:
Z³ are different or the same and selected from C₂-C₁₂-alkylene and C₃-C₁₂-cycloalkylene wherein said C₂-C₁₂-alkylene or C₃-C₁₂-cycloalkylene, respectively, may be nonsubstituted or substituted with one or more O—C₁-C₄-alkyl groups and wherein C₃-C₁₂-cycloalkylene may bear one to three methyl groups,
A³ are different or same and selected from C₁-C₁₂-alkylene, C₆-arylene, and C₃-C₁₂-cycloalkylene wherein C₂-C₁₂-alkylene and C₃-C₁₂-cycloalkylene may be non-substituted or substituted with one or more O—C₁-C₄-alkyl groups or OH groups and wherein C₃-C₁₂-cycloalkylene may bear one to three methyl groups,
or based on citric acid,
X¹ is selected from hydrogen and methyl and ethyl and combinations of at least two of the foregoing,
n is in the range of from 1 to 100,
(e) polyalkylene oxide chains.

Polymers (B4) and methods to make them are disclosed in WO 2022/008416.

In one embodiment of the present invention, polymer (B) is selected from polymers (B5). Polymers (B5) are obtained by first oxidizing polyethylene glycol partially or fully with a catalyst, for example with palladium on charcoal, followed by esterification. In embodiments wherein polyethylene glycol is partially oxidized, for example under formation of polyethylene glycol monocarboxylic acid, no addition of an alcohol component is required. In embodiments wherein Polyethylene glycol dicarboxylic acid is formed, polyalkylene glycol, preferably polyethylene glycol, is added for esterification.

In one embodiment of the present invention, polymer (B) is selected from polymers (B6) that contain sulfonic acid groups and phthalic ester groups. Polymers (B6) are disclosed in EP 2 504 380 A1.

In one embodiment of the present invention, inventive compositions comprise
(C) at least one protease (C), hereinafter also referred to as protease (C).

In one embodiment, at least one protease (C) is selected from the group of serine endopeptidases (EC 3.4.21), most preferably selected from the group of subtilisin type proteases (EC 3.4.21.62). Serine proteases or serine peptidases are characterized by having a serine in the catalytically active site, which forms a covalent adduct with the substrate during the catalytic reaction. A serine protease in the context of the present invention may be selected from the group consisting of chymotrypsin (e.g., EC 3.4.21.1), elastase (e.g., EC 3.4.21.36), elastase (e.g., EC 3.4.21.37 or EC 3.4.21.71), granzyme (e.g., EC 3.4.21.78 or EC 3.4.21.79), kallikrein (e.g., EC 3.4.21.34, EC 3.4.21.35, EC 3.4.21.118, or EC 3.4.21.119,) plasmin (e.g., EC 3.4.21.7), trypsin (e.g., EC 3.4.21.4), thrombin (e.g., EC 3.4.21.5), and subtilisin. Subtilisin is also known as subtilopeptidase, e.g., EC 3.4.21.62, the latter hereinafter also being referred to as “subtilisin”. The subtilisin related class of serine proteases shares a common amino acid sequence defining a catalytic triad which distinguishes them from the chymotrypsin related class of serine proteases. Subtilisins and chymotrypsin related serine proteases both have a catalytic triad comprising aspartate, histidine and serine.

Proteases are active proteins exerting “protease activity” or “proteolytic activity”. Proteolytic activity is related to the rate of degradation of protein by a protease or proteolytic enzyme in a defined course of time.

The methods for analyzing proteolytic activity are known in the literature, see e.g., Gupta et al. (2002), Appl. Microbiol. Biotechnol. 60: 381-395). Proteolytic activity may be determined by using Succinyl-Ala-Ala-Pro-Phe-p-nitroanilide (Suc-AAPF-pNA, short AAPF; see e.g., DelMar et al. (1979), Analytical Biochem 99, 316-320) as substrate. pNA is cleaved from the substrate molecule by proteolytic cleavage, resulting in release of yellow color of free pNA which can be quantified by measuring OD₄₀₅.

Proteolytic activity may be provided in units per gram enzyme. For example, 1 U protease may correspond to the amount of protease which sets free 1 μmol folin-positive amino acids and peptides (as tyrosine) per minute at pH 8.0 and 37° C. (casein as substrate).

Proteases of the subtilisin type (EC 3.4.21.62) may be bacterial proteases originating from a microorganism selected from Bacillus, Clostridium, Enterococcus, Geobacillus, Lactobacillus, Lactococcus, Oceanobacillus, Staphylococcus, Streptococcus, or Streptomyces protease, or a Gram-negative bacterial polypeptide such as a Campylobacter, E. coli, Flavobacterium, Fusobacterium, Helicobacter, Ilyobacter, Neisseria, Pseudomonas, Salmonella, and Ureaplasma.

In one aspect of the invention, at least one protease (C) is selected from Bacillus alcalophilus, Bacillus amyloliquefaciens, Bacillus brevis, Bacillus circulans, Bacillus clausii, Bacillus coagulans, Bacillus firmus, Bacillus gibsonii, Bacillus lautus, Bacillus lentus, Bacillus licheniformis, Bacillus megaterium, Bacillus pumilus, Bacillus sphaericus, Bacillus stearothermophilus, Bacillus subtilis, or Bacillus thuringiensis protease.

In one embodiment of the present invention, at least one protease (C) is selected from the following: subtilisin from Bacillus amyloliquefaciens BPN′; subtilisin from Bacillus licheniformis (subtilisin Carlsberg); subtilisin PB92; subtilisin 147 and/or 309; subtilisin from Bacillus lentus as disclosed in WO 91/02792, such as from Bacillus lentus DSM 5483 or the variants of Bacillus lentus DSM 5483 as described in WO 95/23221; subtilisin from Bacillus alcalophilus; subtilisin from Bacillus gibsonii; subtilisin from Bacillus sp. (DSM 14390); subtilisin from Bacillus sp. (DSM 14392); subtilisin from Bacillus gibsonii (DSM 14393); subtilisin having SEQ ID NO: 4 (Instant SEQ ID NO: 2) as described in WO 2005/063974; subtilisin having SEQ ID NO: 4 (Instant SEQ ID NO: 2) as described in WO 2005/103244; subtilisin having SEQ ID NO: 7 (Instant SEQ ID NO: 3) as described in WO 2005/103244; and subtilisin having SEQ ID NO: 2 (Instant SEQ ID NO: 1) as described in application DE 102005028295.4.

In one embodiment, at least one protease (C) has a sequence according to SEQ ID NO:22 (Instant SEQ ID NO: 4) as described in EP 1921147, or a protease which is at least 80% identical thereto and has proteolytic activity. In one embodiment, said protease is characterized by having amino acid glutamic acid, or aspartic acid, or asparagine, or glutamine, or alanine, or glycine, or serine at position 101 (according to BPN′ numbering) and has proteolytic activity. In one embodiment, said protease comprises one or more further substitutions: (a) threonine at position 3 (3T), (b) isoleucine at position 4 (4I), (c) alanine, threonine or arginine at position 63 (63A, 63T, or 63R), (d) aspartic acid or glutamic acid at position 156 (156D or 156E), (e) proline at position 194 (194P), (f) methionine at position 199 (199M), (g) isoleucine at position 205 (205I), (h) aspartic acid, glutamic acid or glycine at position 217 (217D, 217E or 217G), (i) combinations of two or more amino acids according to (a) to (h).

At least one protease (C) may be at least 80% identical to SEQ ID NO:22 (Instant SEQ ID NO: 4) as described in EP 1921147 and is characterized by comprising one amino acid (according to (a)-(h)) or combinations according to (i) together with the amino acid 101E, 101D, 101N, 101Q, 101A, 101G, or 101S (according to BPN′ numbering). In one embodiment, said protease is characterized by comprising the mutation (according to BPN′ numbering) R101E, or S3T+V4I+V205I, or R101E and S3T, V4I, and V205I, or S3T+V4I+V199M+V205I+L217D, and having proteolytic activity. A protease having a sequence according to SEQ ID NO: 22 (Instant SEQ ID NO: 4) as described in EP 1921147 with 101E may be called Lavergy herein.

In one embodiment, protease according to SEQ ID NO:22 (Instant SEQ ID NO: 4) as described in EP 1921147 is characterized by comprising the mutation (according to BPN′ numbering) S3T+V4I+S9R+A15T+V68A+D99S+R101S+A103S+I104V+N218D, and by having proteolytic activity.

Inventive compositions may comprise a combination of at least two proteases, preferably selected from the group of serine endopeptidases (EC 3.4.21), more preferably selected from the group of subtilisin type proteases (EC 3.4.21.62)—all as disclosed above.

It is preferred to use a combination of lipase (C) and protease (C) in compositions, for example 1 to 2% by weight of protease (C) and 0.1 to 0.5% by weight of lipase (C), both referring to the total weight of the composition.

In the context of the present invention, lipase (C) and/or protease (C) is deemed stable when its enzymatic activity “available in application” equals at least 60% when compared to the initial enzymatic activity before storage. An enzyme may be called stable within this invention if its enzymatic activity available in application is at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or at least 99.5% when compared to the initial enzymatic activity before storage.

Subtracting a % from 100% gives the “loss of enzymatic activity during storage” when compared to the initial enzymatic activity before storage. In one embodiment, an enzyme is stable according to the invention when essentially no loss of enzymatic activity occurs during storage, i.e. loss in enzymatic activity equals 0% when compared to the initial enzymatic activity before storage. Essentially no loss of enzymatic activity within this invention may mean that the loss of enzymatic activity is less than 30%, less than 25%, less than 20%, less than 15%, less than 10%, less than 9%, less than 8%, less than 7%, less than 6%, less than 5%.

In one embodiment of the present invention, protease (C) is selected from lipases (C).

“Lipases”, “lipolytic enzyme”, “lipid esterase”, all refer to enzymes of EC class 3.1.1 (“carboxylic ester hydrolase”). Such a lipase (C) may have lipase activity (or lipolytic activity; triacylglycerol lipase, EC 3.1.1.3), cutinase activity (EC 3.1.1.74; enzymes having cutinase activity may be called cutinase herein), sterol esterase activity (EC 3.1.1.13) and/or wax-ester hydrolase activity (EC 3.1.1.50). Lipases (C) include those of bacterial or fungal origin.

Commercially available lipases (C) include but are not limited to those sold under the trade names Lipolase™, Lipex™, Lipolex™ and Lipoclean™ (Novozymes A/S), Preferenz™ L (DuPont), Lumafast (originally from Genencor) and Lipomax (Gist-Brocades/now DSM).

Suitable lipases (B) include also those that are variants of the above described lipases which have lipolytic activity. Suitable lipase variants include variants with at least 40 to 99% identity when compared to the full length polypeptide sequence of the parent enzyme as disclosed above.

Lipases (B) have “lipolytic activity”. The methods for determining lipolytic activity are well-known in the literature (see e.g. Gupta et al. (2003), Biotechnol. Appl. Biochem. 37, p. 63-71). E.g., the lipase activity may be measured by ester bond hydrolysis in the substrate para-nitrophenyl palmitate (pNP-Palmitate, C:16) and releases pNP which is yellow and can be detected at 405 nm.

In one embodiment, lipase (C) is selected from fungal triacylglycerol lipase (EC class 3.1.1.3). Fungal triacylglycerol lipase may be selected from lipases of Thermomyces lanuginosa. In one embodiment, at least one Thermomyces lanuginosa lipase is selected from triacylglycerol lipase according to amino acids 1-269 of SEQ ID NO: 2 (Instant SEQ ID NO: 1) of U.S. Pat. No. 5,869,438 and variants thereof having lipolytic activity.

Thermomyces lanuginosa lipase may be selected from variants having lipolytic activity which are at least 90%, at least 91%, at least 92%, at least 93%, at least 94%, at least 95%, at least 96%, at least 97%, at least 98% or at least 99% identical when compared to the full length polypeptide sequence of amino acids 1-269 of SEQ ID NO: 2 (Instant SEQ ID NO: 1) of U.S. Pat. No. 5,869,438.

Thermomyces lanuginosa lipase may be selected from variants having lipolytic activity comprising conservative mutations only, which do not pertain the functional domain of amino acids 1-269 of SEQ ID NO: 2 (Instant SEQ ID NO: 1) of U.S. Pat. No. 5,869,438. Lipase variants of this embodiment having lipolytic activity may be at least 95%, at least 96%, at least 97%, at least 98% or at least 99% similar when compared to the full length polypeptide sequence of amino acids 1-269 of SEQ ID NO: 2 (Instant SEQ ID NO: 1) of U.S. Pat. No. 5,869,438.

Thermomyces lanuginosa lipase may be selected from variants having lipolytic activity comprising at least the following amino acid substitutions when compared to amino acids 1-269 of SEQ ID NO: 2 (Instant SEQ ID NO: 1) of U.S. Pat. No. 5,869,438: T231R and N233R. Said lipase variants may further comprise one or more of the following amino acid exchanges when compared to amino acids 1-269 of SEQ ID NO: 2 (Instant SEQ ID NO: 1) of U.S. Pat. No. 5,869,438: Q4V, V60S, A150G, L227G, P256K.

Thermomyces lanuginosa lipase may be selected from variants having lipolytic activity comprising at least the amino acid substitutions T231R, N233R, Q4V, V60S, A150G, L227G, P256K within the polypeptide sequence of amino acids 1-269 of SEQ ID NO: 2 (Instant SEQ ID NO: 1) of U.S. Pat. No. 5,869,438 and are at least 95%, at least 96%, or at least 97% similar when compared to the full length polypeptide sequence of amino acids 1-269 of SEQ ID NO: 2 (Instant SEQ ID NO: 1) of U.S. Pat. No. 5,869,438.

Thermomyces lanuginosa lipase may be selected from variants having lipolytic activity comprising the amino acid substitutions T231R and N233R within amino acids 1-269 of SEQ ID NO: 2 (Instant SEQ ID NO: 1) of U.S. Pat. No. 5,869,438 and are at least 95%, at least 96%, at least 97%, at least 98%, or at least 99% similar when compared to the full length polypeptide sequence of amino acids 1-269 of SEQ ID NO: 2 (Instant SEQ ID NO: 1) of U.S. Pat. No. 5,869,438.

Thermomyces lanuginosa lipase may be a variant of amino acids 1-269 of SEQ ID NO: 2 (Instant SEQ ID NO: 1) of U.S. Pat. No. 5,869,438 having lipolytic activity, wherein the variant of amino acids 1-269 of SEQ ID NO: 2 (Instant SEQ ID NO: 1) of U.S. Pat. No. 5,869,438 is characterized in containing the amino acid substitutions T231R and N233R. Said lipase may be called Lipex herein.

In one embodiment of the present invention, a combination of at least two of the foregoing lipases (B) may be used.

In one embodiment of the present invention, lipases (B) are included in inventive composition in such an amount that a finished inventive composition has a lipolytic enzyme activity in the range of from 100 to 0.005 LU/mg, preferably 25 to 0.05 LU/mg of the composition. A Lipase Unit (LU) is that amount of lipase which produces 1 μmol of titratable fatty acid per minute in a pH stat. under the following conditions: temperature 30° C.; pH=9.0; substrate is an emulsion of 3.3 wt. % of olive oil and 3.3% gum arabic, in the presence of 13 mmol/l Ca²⁺ and 20 mmol/l NaCl in 5 mmol/l Tris-buffer.

In one embodiment of the present invention, inventive compositions comprise at least one surfactant (D), for example anionic surfactant (D) or non-ionic surfactant (D).

Examples of anionic surfactants (D) are alkali metal and ammonium salts of C₈-C₁₈-alkyl sulfates, of C₈-C₁₃-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Further examples of anionic surfactants (D) are soaps, for example the sodium or potassium salts of stearic acid, oleic acid, palmitic acid, ether carboxylates, and alkylether phosphates.

In a preferred embodiment of the present invention, anionic surfactant (D) is selected from compounds according to general formula (III)

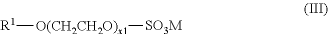

wherein
R¹ n-C₁₀-C₁₈-alkyl, especially with an even number of carbon atoms, for example n-decyl, n-dodecyl, n-tetradecyl, n-hexadecyl, or n-octadecyl, preferably C₁₀-C₁₄-alkyl, and even more preferably n-C₁₂-alkyl,
x1 being a number in the range of from 1 to 5, preferably 2 to 4 and even more preferably 3.
M being selected from alkali metals, preferably potassium and even more preferably sodium.

In anionic surfactant (D), x1 may be an average number and therefore n is not necessarily a whole number, while in individual molecules according to formula (III a), x denotes a whole number.

In one embodiment of the present invention, inventive compositions may contain 0.1 to 60% by weight of anionic surfactant (D), preferably 5 to 50% by weight.

Inventive compositions may comprise ingredients other than the aforementioned. Examples are non-ionic surfactants, fragrances, dyestuffs, biocides, preservatives, enzymes, hydrotropes, builders, viscosity modifiers, polymers, buffers, defoamers, and anti-corrosion additives.

Preferred inventive compositions may contain one or more non-ionic surfactants.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (III a)

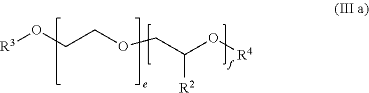

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,

The variables e and f are in the range from zero to 300, where the sum of e and f is at least one, preferably in the range of from 3 to 50. Preferably, e is in the range from 1 to 100 and f is in the range from 0 to 30.

In one embodiment, compounds of the general formula (II) may be block copolymers or random copolymers, preference being given to block copolymers.

Other preferred examples of alkoxylated alcohols are, for example, compounds of the general formula (III b)

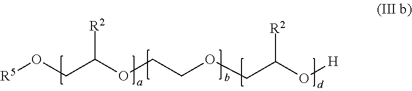

in which the variables are defined as follows:
R² is identical or different and selected from hydrogen and linear C₁-C₀-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Compounds of the general formula (III a) and (III b) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (IV) are likewise suitable.

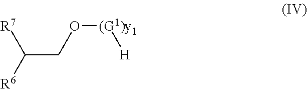

wherein:
R⁶ is C₁-C₄-alkyl, in particular ethyl, n-propyl or isopropyl,
R⁷ is —(CH₂)₂—R⁶,
G¹ is selected from monosaccharides with 4 to 6 carbon atoms, especially from glucose and xylose,
y1 in the range of from 1.1 to 4, y1 being an average number,

Further examples of non-ionic surfactants are compounds of general formula (V) and (VI)

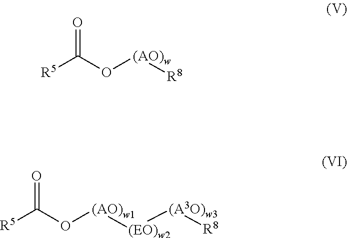

AO is selected from ethylene oxide, propylene oxide and butylene oxide, EO is ethylene oxide, CH₂CH₂—O,
R⁸ selected from C₈-C₁₈-alkyl, branched or linear, and R⁵ is defined as above.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DEA 198 19 187.

Mixtures of two or more different nonionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (VII)

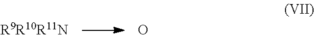

wherein R⁹, R¹⁰, and R¹¹ are selected independently from each other from aliphatic, cycloaliphatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁰ and R¹¹ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

In one embodiment of the present invention, inventive compositions may contain 0.1 to 60% by weight of at least one surfactant, selected from non-ionic surfactants, amphoteric surfactants and amine oxide surfactants.

Inventive compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate.

Examples of organic peroxide bleaches are organic percarboxylic acids, especially organic percarboxylic acids.

In inventive compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive compositions may comprise, for example, in the range from 3 to 10% by weight of chlorine-containing bleach.

Inventive compositions may comprise one or more bleach catalysts. Bleach catalysts can be selected from bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive compositions may comprise one or more bleach activators, for example N-methylmorpholinium-acetonitrile salts (“MMA salts”), trimethylammonium acetonitrile salts, N-acylamides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

Examples of fragrances are benzyl salicylate, 2-(4-tert.-butylphenyl) 2-methylpropional, commercially available as Lilial®, and hexyl cinnamaldehyde.

Examples of dyestuffs are Acid Blue 9, Acid Yellow 3, Acid Yellow 23, Acid Yellow 73, Pigment Yellow 101, Acid Green 1, Solvent Green 7, and Acid Green 25.

Inventive compositions may contain one or more preservatives or biocides. Biocides and preservatives prevent alterations of inventive liquid laundry detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (“MIT”) and 5-chloro-2-methyl-2H-isothiazol-3-one (“CIT”), benzoic acid, sorbic acid, iodopropynyl butylcarbamate (“IPBC”), dichlorodimethylhydantoine (“DCDMH”), bromochlorodimethylhydantoine (“BCDMH”), and dibromodimethylhydantoine (“DBDMH”).

Examples of viscosity modifiers are agar-agar, carrageen, tragacanth, gum arabic, alginates, pectins, hydroxyethyl cellulose, hydroxypropyl cellulose, starch, gelatin, locust bean gum, crosslinked poly(meth)acrylates, for example polyacrylic acid cross-linked with bis-(meth)acrylamide, furthermore silicic acid, clay such as—but not limited to—montmorillonite, zeolite, dextrin, and casein.

Hydrotropes in the context with the present invention are compounds that facilitate the dissolution of compounds that exhibit limited solubility in water. Examples of hydrotropes are organic solvents such as ethanol, isopropanol, ethylene glycol, 1,2-propylene glycol, and further organic solvents that are water-miscible under normal conditions without limitation. Further examples of suitable hydrotropes are the sodium salts of toluene sulfonic acid, of xylene sulfonic acid, and of cumene sulfonic acid.

Examples of polymers other than polymer (B) are especially polyacrylic acid and its respective alkali metal salts, especially its sodium salt. A suitable polymer is in particular polyacrylic acid, preferably with an average molecular weight M_{w} in the range from 2,000 to 40,000 g/mol. preferably 2,000 to 10,000 g/mol, in particular 3,000 to 8,000 g/mol, each partially or fully neutralized with alkali, especially with sodium. Suitable as well are copolymeric polycarboxylates, in particular those of acrylic acid with methacrylic acid and of acrylic acid or methacrylic acid with maleic acid and/or fumaric acid. Polyacrylic acid and its respective alkali metal salts may serve as soil anti-redeposition agents.

Further examples of polymers are polyvinylpyrrolidones (PVP). Polyvinylpyrrolidones may serve as dye transfer inhibitors.

Further examples of polymers are polyethylene terephthalates, polyoxyethylene terephthalates, and polyethylene terephthalates that are end-capped with one or two hydrophilic groups per molecule, hydrophilic groups being selected from CH₂CH₂CH₂—SO₃Na, CH₂CH(CH₂—SO₃Na)₂, and CH₂CH(CH₂SO₂Na)CH₂—SO₃Na.

Examples of buffers are monoethanolamine and N,N,N-triethanolamine.

Examples of defoamers are silicones.

Inventive compositions are not only good in cleaning soiled laundry with respect to organic fatty soil such as oil. Inventive liquid detergent compositions are very useful for removing nonbleachable stains such as, but not limited to stains from red wine, tea, coffee, vegetables, and various fruit juices like berry juices from laundry. They still do not leave residues on the clothes.

A further aspect of the present invention is therefore the use of inventive compositions for laundry care. Laundry care in this context includes laundry cleaning. In the context of the present invention, the expressions “liquid laundry detergent compositions” and liquid laundry compositions” may be used interchangeably.

In another aspect, inventive compositions are useful for hard surface cleaning. A further aspect of the present invention is therefore the use of inventive compositions for hard surface cleaning.

In the context of the present invention, the term “composition for hard surface cleaning” includes cleaners for home care and for industrial or institutional applications. The term “composition for hard surface cleaning” includes compositions for dishwashing, especially hand dishwash and automatic dishwashing and ware-washing, and compositions for hard surface cleaning such as, but not limited to compositions for bathroom cleaning, kitchen cleaning, floor cleaning, descaling of pipes, window cleaning, car cleaning including truck cleaning, furthermore, open plant cleaning, cleaning-in-place, metal cleaning, disinfectant cleaning, farm cleaning, high pressure cleaning, but not laundry detergent compositions. A special embodiment of compositions for hard surface cleaning are automatic dishwashing compositions.

In the context of the present invention, the terms “compositions for hard surface cleaning” and “compositions for hard surface cleaners” are used interchangeably.

In the context of the present invention and unless expressly stated otherwise, percentages in the context of ingredients of laundry detergent compositions are percentages by weight and refer to the total solids content of the respective laundry detergent composition. In the context of the present invention and unless expressly stated otherwise, percentages in the context of ingredients of detergent composition for hard surface cleaners are percentages by weight and refer to the total solids content of the detergent composition for hard surface cleaning.

Inventive compositions when used for automatic dishwashing preferably contain

(E) at least one builder component selected from aminopolycarboxylic acids and preferably their alkali metal salts, in the context of the present invention also referred to as complexing agent (E) or sequestrant (E). In the context of the present invention, the terms sequestrants and chelating agents are used interchangeably.

Examples of sequestrants (E) are alkali metal salts of MGDA (methyl glycine diacetic acid), GLDA (glutamic acid diacetic acid), IDS (iminodisuccinate), EDTA, and polymers with complexing groups like, for example, polyethylenimine in which 20 to 90 mole-% of the N-atoms bear at least one CH₂COO— group, and their respective alkali metal salts, especially their sodium salts, for example MGDA-Na₃, GLDA-Na₄, or IDS-Na₄.

Preferred sequestrants are those according to general formula (IX a)

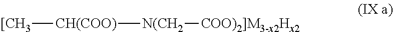

wherein M is selected from ammonium and alkali metal cations, same or different, for example cations of sodium, potassium, and combinations of at least two of the foregoing. Ammonium may be substituted with alkyl but non-substituted ammonium NH₄⁺ is preferred. Preferred examples of alkali metal cations are sodium and potassium and combinations of sodium and potassium, and even more preferred in compound according to general formula (II a) all M are the same and they are all Na;
and x2 in formula (II a) is in the range of from zero to 1.0,

### or (IX b)

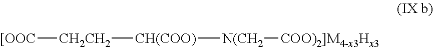

wherein M is as defined above, and x3 in formula (IX b) is in the range of from zero to 2.0, preferably to 1.0,

### or (IX c)

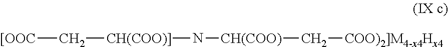

wherein M is as defined above, and x4 in formula (IX c) is in the range of from zero to 2.0, preferably to 1.0.

In one embodiment of the present invention, said inventive composition contains a combination of at least two of the foregoing, for example a combination of chelating agent according to general formula (IX a) and a chelating agent according to general formula (IX b).

Chelating agents according to the general formulae (IX a) and (IX b) are preferred. Even more preferred are chelating agents according to the general formula (IX a).

In one embodiment of the present invention, compound according to general formula (IX a) is selected from ammonium or alkali metal salt of racemic MGDA and from ammonium and alkali metal salts of mixtures of L- and D-enantiomers according to formula (IX a), said mixture containing predominantly the respective L-isomer with an enantiomeric excess (ee) in the range of from 5 to 99%, preferably 5 to 95%, more preferably from 10 to 75% and even more preferably from 10 to 66%.

In one embodiment of the present invention, compound according to general formula (IX b) is selected from at least one alkali metal salt of a mixture of L- and D-enantiomers according to formula (IX b), said mixture containing the racemic mixture or preferably predominantly the respective L-isomer, for example with an enantiomeric excess (ee) in the range of from 5 to 99%, preferably 15 to 95%.

The enantiomeric excess of compound according to general formula (IX a) may be determined by measuring the polarization (polarimetry) or preferably by chromatography, for example by HPLC with a chiral column, for example with one or more cyclodextrins as immobilized phase or with a ligand exchange (Pirkle-brush) concept chiral stationary phase. Preferred is determination of the ee by HPLC with an immobilized optically active amine such as D-penicillamine in the presence of copper(+II) salt. The enantiomeric excess of compound according to general formula (IX b) salts may be determined by measuring the polarization (polarimetry).

Due to the environmental concerns raised in the context with the use of phosphates, it is preferred that advantageous compositions are free from phosphate. “Free from phosphate” should be understood in the context of the present invention as meaning that the content of phosphate and polyphosphate is in sum in the range of from detection level to 1% by weight, preferably from 10 ppm to 0.2% by weight, determined by gravimetry.

In one embodiment of the present invention, inventive compositions contain in the range of from 0.5 to 50% by weight of sequestrant (E), preferably 1 to 35% by weight, referring to the total solids content.

In order to be suitable as liquid laundry compositions, inventive compositions may be in bulk form or as unit doses, for example in the form of sachets or pouches. Suitable materials for pouches are water-soluble polymers such as polyvinyl alcohol.

In a preferred embodiment of the present invention, inventive liquid laundry compositions are liquid or gel-type at ambient temperature.

In one embodiment of the present invention, inventive compositions are liquid or gel-type and have a pH value in the range of from 7 to 9, preferably 7.5 to 8.51n embodiments where inventive compositions are used for hard surfaces like tiles, for example bathroom tiles, their pH value may even be acidic, for example from 3 to 6.

In one embodiment of the present invention, inventive compositions are liquid or gel-type and have a total solids content in the range of from 8 to 80%, preferably 10 to 50%, determined by drying under vacuum at 80° C.

In one embodiment of the present invention, inventive composition are liquid at ambient temperature and have a dynamic viscosity in the range of from 400 to 1200 mPa·s, determined at 20° C. according to Anton Paar, in a rotary viscosimeter.

Inventive compositions may contain one or more preservatives or biocides. Biocides and preservatives prevent alterations of inventive liquid detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (“MIT”) and 5-chloro-2-methyl-2H-isothiazol-3-one (“CIT”), 2-butyl-benzo[d]isothiazol-3-one (BBIT), 2-octyl-2H-isothiazol-3-one (OIT);
benzoic acid, sorbic acid and their salts, e.g., sodium benzoate, ammonium benzoate, calcium benzoate, magnesium benzoate, MEA-benzoate, potassium benzoate, calcium sorbate, sodium sorbate, iodopropynyl butylcarbamate (“IPBC”), dichlorodimethylhydantoine (“DCDMH”), bromochlorodimethylhydantoine (“BCDMH”), and dibromodimethylhydantoine (“DBDMH”).

Particularly of interest are the following antimicrobial agents and/or preservatives: 4,4′-dichloro 2-hydroxydiphenyl ether, further names: 5-chloro-2-(4-chlorophenoxy) phenol, Diclosan, DCPP that is commercially available as a solution of 30 wt % of 4,4′-dichloro 2-hydroxydiphenyl ether in 1,2 propyleneglycol,
2-Phenoxyethanol, further names: Phenoxyethanol, Methylphenylglycol, Phenoxetol, ethylene glycol phenyl ether, Ethylene glycol monophenyl ether);
2-bromo-2-nitropropane-1,3-diol, further names: 2-bromo-2-nitro-1,3-propanediol, Glutaraldehyde (CAS-No. 111-30-8, further names: 1-5-pentanedial, pentane-1,5-dial, glutaral, glutardialdehyde, Glyoxal (further names: ethandial, oxalaldehyde, 1,2-ethandial);
Mixtures of 5-chloro-2-methyl-2H-isothiazol-3-one (CMIT) and 2-methyl-2H-isothiazol-3-one (MIT, EINECS 220-239-6) (mixture of CMIT/MIT); potassium (E,E)-hexa-2,4-dienoate (Potassium Sorbate); lactic acid and its salts; especially sodium lactate, especially L-(+)-lactic acid,
Salicylic acid and its salts, e.g., calcium salicylate, magnesium salicylate, MEA salicylate, sodium salicylate, potassium salicylate, and TEA salicylate.

Benzalkonium chloride, benzalkonium bromide, benzalkonium saccharinate, didecyldimethylammonium chloride (DDAC); N-(3-aminopropyl)-N-dodecylpropane-1,3-diamine (Diamine); peracetic acid, and hydrogen peroxide.

Biocide or preservative may be added to inventive composition in a concentration of 0.001 to 10% relative to the total weight of the composition.

Preferably, inventive composition contains 2-phenoxyethanol in a concentration of 0.1 to 2% or 4,4′-dichloro 2-hydroxydiphenyl ether (DCPP) in a concentration of 0.005 to 0.6%.

The present invention thus further pertains to a method of preserving an inventive aqueous composition against microbial contamination or growth, which method comprises addition of 2-phenoxyethanol.

The present invention thus further pertains to a method of providing an antimicrobial effect on textiles after treatment with an inventive liquid laundry detergent containing 4,4′-dichloro 2-hydroxydiphenyl ether (DCPP).

In one aspect, the invention is directed to a method of improving the cleaning performance of a liquid laundry detergent composition, by adding
(A) a combination of compounds comprising
(α) triethanolamine, and
(β) citric acid or a mono- or diammonium salt of citric acid, ammonium being selected from alkylammonium and alkanolammonium.

Said addition may occur by separate addition or by adding a combination of compound (α) and compound (β).

Said liquid laundry detergent composition further contains at least one polymer (B).

Hydrolase (C) and polymer (B) have been described in more detail, vide supra.

In one embodiment of the present invention, said liquid laundry detergent composition is free from phosphate.

The term “improved cleaning performance” herein may indicate that combinations (A) provide better, i.e., improved, properties in stain removal under relevant cleaning conditions, when compared to the cleaning performance of a detergent composition lacking polymer (B) and, optionally, hydrolase (C). In particular, though, the addition of a combination (A) leads to an improved shelf-life of polymer (B) with or without hydrolase (C).

In one embodiment, “improved cleaning performance” means that the cleaning performance of a detergent comprising polymer (B), without or with at least one hydrolase (C), especially with at least one lipase (C) and/or at least one protease (C), is improved when compared to the cleaning performance of a detergent comprising polymer (B) and no combination (A).

The term “relevant cleaning conditions” herein refers to the conditions, particularly cleaning temperature, time, cleaning mechanics, suds concentration, type of detergent and water hardness, actually used in laundry machines, automatic dish washers or in manual cleaning processes.

Preferably, said liquid laundry detergent composition is an aqueous composition.

In one embodiment of the present invention, said liquid detergent composition has a pH value in the range of from 7.5 to 8.5.

In one embodiment of the present invention, said liquid detergent composition has a sodium content below 2.0% by weight, preferably below 0.5% by weight, referring to the total solids content of said composition, more preferably 0.001 to 0.4% by weight. The total solids content may be determined by removing water and solvents at a temperature of from 60 to 80° C., at a pressure of 40 to 100 mbar until constant weight.

Compound (α) and compound (β) have been described in more detail above.

In one embodiment of the present invention, the total molar ratio of N—CH₂CH₂—OH groups of compound (α) to carboxylate groups from compound (β) is in the range of from 1:10 to 10:1.

The invention is further illustrated by working examples.

### EXAMPLES

### Synthesis of MCDA×2EO, (α.3)

A 2-l autoclave with propeller stirrer was charged with 512 g methylcyclohexyldiamine and 80 g of water and then evacuated and purged with nitrogen three times. Then, the autoclave was heated to 125° C. An amount of 355 of ethylene oxide was added within 2.5 hours under stirring and allowed to react for additional 45 Minutes at 130° C. The mixture so obtained was cooled to 90° C., and the volatile ingredients were removed in vacuo. An amount of 895 g of a highly viscous brownish liquid was obtained, (α.3).

### Synthesis of N4Amine×2PO, (α.4)

A 2-l autoclave with propeller stirrer was charged with 356 g N4-Amine (N,N′-bis(3-aminopropyl)ethylenediamine) and 55 g of water and then evacuated and purged with nitrogen three times. Then, the autoclave was heated to 125° C. An amount of 230 of propylene oxide (“PO”) was added within 2 hours under stirring and allowed to react for additional 90 Minutes at 130° C. The mixture so obtained was cooled to 90° C., and the volatile ingredients were removed in vacuo. An amount of 682 g of a highly viscous brownish liquid was obtained, (α.4).

### I. Manufacture of Combinations (A)

### I.1 Manufacture of Combination (A.1)

A 2-l glass vessel with stirrer and funnel was charged with 550 g (3.7 mol) triethanolamine (α.1). 260 g water were added. Within 15 minutes, 210 g citric acid (β.1) monohydrate (1.0 mol) were added through a funnel. The pH of the resultant clear liquid, combination (A.1), was 7.6. Molar ratio of N—CH₂CH₂—OH groups to COOH groups: 1.2:1.

### I.2 Manufacture of Combination (A.2)

A 2-l glass vessel with stirrer and funnel was charged with 150 g (1.0 mol) triethanolamine (α.1) and 159 g (2.6 mol) ethanolamine (α.2). 260 g water were added. Within 15 minutes, 225 g citric acid monohydrate (β.1) (1.07 mol) were added through a funnel. The pH value of the resultant clear liquid, combination (A.2), was 7.5. Molar ratio of N—CH₂CH₂OH groups to COOH groups: 1.1:1.

### I.3 Manufacture of Combination (A.3)

A 2-l glass vessel with stirrer and funnel was charged with 300 g (2.0 mol) triethanolamine (α.1). 260 g water and 190 g MCDA as mixture of isomers were added. Within 20 minutes, 265 g citric acid monohydrate (β.1) (1.26 mol) were added through a funnel. The pH value of the resultant clear liquid, combination (A.3), was 7.25. Molar ratio of N—CH₂CH(X¹)OH groups to COOH groups: 1.9:1.

### I.4 Manufacture of Combination (A.4)

A 2-l glass vessel with stirrer and funnel was charged with 300 g (2.0 mol) triethanolamine (α.1) and 320 g (1.5 mol) (α.3). 260 g water were added. Within 30 minutes, 265 g citric acid monohydrate (β.1) (1.26 mol) were added through a funnel. The pH of the resultant clear liquid, combination (A.4), was 7.1. Molar ratio of N—CH₂CH₂OH groups to COOH groups: 1.3:1.

### I.5 Manufacture of Combination (A.5)

A 2-l glass vessel with stirrer and funnel was charged with 300 g (2.0 mol) triethanolamine (α.1) and 320 g (1.1 mol) (α.4). 145 g water were added. Within 30 minutes, 265 g citric acid monohydrate (β.1) (1.26 mol) were added through a funnel. The pH value of the resultant clear liquid combination (A.5) was 7.35. Molar ratio of N—CH₂CHX¹OH groups to COOH groups: 1.1:1.

### II. Manufacture of Polymers (B)

### II.1 Manufacture of Polymers (B1)

TABLE 1
Starting materials - backbone molecules (a)

| | | | | OH/NH | |
|---|---|---|---|---|---|
| | | | | number | |
| Number | Base amine | AO/N—H | Mₙ [g] | [mg KOH/g] | M_{w}/Mₙ |
| (a.1) | N4Amine | 5 PO | 1910 | 176 | 1.15 |
| (a.2) | polyethylenimine | 1 EO | 1450 | 652 | 1.28 |

EO—ethylene oxide,
PO—propylene oxide
n.d.—not determined/not applicable
N4Amine: N,N-Bis(3-aminopropyl)-1,2-ethanediamine
polyethylenimine: branched polyethylenimine, M_{w} 800 g

TABLE 2
Starting materials - blocks (b)

| | Base polyalkylene | Monoacid | Diacid | Appearance | OH number | acid number |
|---|---|---|---|---|---|---|
| Number | glycol, M_{W} [g] | [%] | [%) | at 20° C. | [mg KOH/g] | [mg KOH/g] |
| (b.1) | PEG, 200 | 21.7 | 74.7 | liquid | 251 | 460.3 |
| (b.9) | MPEG, 1000 | 85.3 | — | solid | 227 | 47.0 |

MPEG: monomethyl ether of polyethylene glycol,
PEG: polyethylene glycol,
PPG: polypropylene glycol

### II.1.1 Synthesis of Polymer (B1.1)

A 250-ml flask equipped with stirrer, Dean-Stark apparatus, nitrogen inlet and inside thermometer was charged with backbone (a.1) and citric acid, in a molar ratio of 1:1. An amount of 0.15 g Ti(IV) tetra-isobutylate was added. The reaction mixture was then heated to 160° C. (inside temperature). Water distilled off. Stirring at 160° C. was continued under nitrogen for 4 hours. Then, oxidized polyethylene glycol, Mₙ 200 g/mol, molar ratio monoacid:diacid 2:7, was added and heating and water removal were continued for 1.5 hours. The resultant polymer (B1.1) was collected as a solid material. GPC in HFIP: Mₙ 5600 g/mol, M_{w} 21,600 g/mol

### II.1.2 Synthesis of Polymer (B1.2)

A 250-ml flask equipped with stirrer, Dean-Stark apparatus, nitrogen inlet and inside thermometer was charged with backbone molecule (a.2) (0.69 mol) and 0.2 g Ti(IV) tetra-isobutylate. Then, oxidized monomethyl ether of polyethylene glycol, COOH groups to OH groups 85:15 molar ratio, was added. The reaction mixture was then heated to 160° C. (inside temperature). Water was distilled off. Stirring at 160° C. was continued under nitrogen for 4½ hours. and heating and water removal were continued for 1.5 hours. The resultant polymer (B1.2) was collected as a paste.

GPC in HFIP: Mₙ 5,300 g/mol, M_{w} 14,160 g/mol

Polymers (B3.1), (B3.2) and (B3.3) correspond to polymers (A1.2), (A.3.1) and (A.4.1) of WO 2022/008416, respectively.

### III. Manufacture of Inventive Compositions and Stability Tests

Percentages are percent per weight unless specifically indicated otherwise

### III.1 Storage Tests and IR Detection

Inventive formulations were manufactured by mixing 85 g of LLF.1 or LLF.2, respectively, Table 3 “15% gap”, with 5 g of respective polymer (B) and 5 to 8 g of combination (A.1) to (A.5) in accordance with Table 5 and then filling up with water to 100 g.

The ester-bonds of the polymers were detected through infrared spectroscopy (“IR”) and the CO peak between 1730 and 1760 cm⁻¹ and the C—O—C control band-frequency at 1240 cm⁻¹. The intensity of the bands was set as 100% at the point before storage and compared to the intensity after storage at various times.

After storage over 3 weeks at 50° C. (simulating ca. 4 to 6 months at 20° C.) the IR spectra were measured again and the decrease in intensity of the ester bands was correlated with the degradation of the polymer (B).

For comparison purposes, analogous experiments were performed without a combination (A) in water, in LLF.1 and in LLF.2.

TABLE 3
Liquid laundry formulations LLF.1 and LLF.2

| | Solids | | | | |
|---|---|---|---|---|---|
| | content | LLF.1 | | LLF.2 | |
| Ingredient | [%] | [%] | [g] | [%] | [g] |
| De-ionized water | | | 433.95 | | 447.04 |
| NH₃ free | | | | | |
| n-dodecylbenzenesulfonic | 97% | 5.5 | 56.70 | 6.6 | 68.04 |
| free acid | | | | | |
| C₁₂H₂₅—N[(CH₂CH₂O)₂H]₂ | 100% | 2.4 | 24.00 | 2.4 | 24.00 |
| n-C₁₂H₂₅—O—(CH₂CH₂O)₃—SO₃Na, | 70% | 5.4 | 77.14 | 4.6 | 65.71 |
| NaOH | 50% | 2.2 | 44.00 | 2.5 | 50.00 |
| trisodiumcitrate | 100% | 3.0 | 30.00 | 2.0 | 20.00 |
| n-C₁₈H₃₇—O(CH₂CH₂O)₇—H | 100% | 5.4 | 54.00 | 6.5 | 65.00 |
| 1,2 Propylene glycol | 100% | 6.0 | 60.00 | 6.0 | 60.00 |
| Ethanol | 99% | 2.0 | 20.20 | 2.0 | 20.20 |
| amount (referring | | 31.90 | 366.05 | 30.6 | 353.0 |
| to actives) | | | | | |
| water (15% gap) | | to 85 | to 850 | to 85 | to 850 |
| Laundry detergent | | 100 | 1000 | 100 | 1000 |
| pH value | | | 8.0 | | 8.0 |

TABLE 4
Inventive and comparative storage tests and infrared (IR) monitoring

| | | | IR CO | IR CO | IR-CO | IR-CO | IR-CO |
|---|---|---|---|---|---|---|---|
| | | | intensity | Intensity | intensity | intensity | intensity |
| | Combi- | IR CO | after storage | after storage | after storage | after storage | after storage |
| | nation | peak- | in LLF.1 | in LLF.2 | without (A) | in LLF.1 in | in LLF.2 in |
| | (A) | frequency, | with (A), | with (A), | without LLF, | absence of | absence of |
| (B) | [%] | [cm⁻¹] | [%] | [%] | [%] | (A), [%] | (A), [%] |
| (B1.1) | (A.1) 5% | 1744 | 90 | 85 | 50 | 60 | 55 |
| (B1.2) | (A.2) 5% | 1748 | 85 | 82 | 50 | 45 | 45 |
| (B3.1) | (A.3) 6% | 1731 | 82 | 74 | 45 | 60 | 65 |
| (B3.2) | (A.4) 8% | 1738 | 86 | 80 | 40 | 60 | 60 |
| (B3.3) | (A.5) 8% | 1733 | 83 | 78 | 45 | 55 | 60 |

CO: carbonyl group

### III.2 Storage Test and Molecular Weight Detection

### General Protocol:

Polymer (B) was diluted with water to yield a 20% aqueous solution. The pH value was adjusted to 8.0 to 8.3 with a combination (A) and the resulting solutions were stored for 3 weeks at 50° C. GPC analysis confirmed the degree of degradation over storage. In comparative experiments, polymer (B) was diluted with water to yield a 20% by weight aqueous solution but without addition of a combination (A). The pH value was adjusted to 8.0 with either citric acid or ethanolamine.

TABLE 5
storage tests in water and molecular weight detection

| | Combi- | | | | Comparative: | |
|---|---|---|---|---|---|---|
| | nation | M_{w} before | M_{w} after | pH value | M_{w} after storage | pH value after |
| | (A), | storage, | storage, | after | without (A), | storage with- |
| polymer | [%] | [g/mol] | [g/mol] | storage | [g/mol] | out (A) |
| (B1.1) | (A.1) 5% | 22,600 | 17,900 | 7.6 | 8,960 | 6.8 |
| (B1.2) | (A.2) 5% | 14,160 | 11,420 | 7.4 | 6,480 | 6.0 |
| (B3.1) | (A.3) 6% | 59,570 | 34,800 | 7.0 | 21,520 | 6.3 |
| (B3.2) | (A.4) 8% | 14,685 | 10,780 | 7.3 | 5,180 | 5.9 |
| (B3.3) | (A.5) 8% | 34,780 | 23,700 | 7.1 | 12,100 | 6.0 |

Percentages of (A) refer to the entire aqueous solution

1. A liquid laundry composition comprising
(A) at least one combination of compounds comprising
(α) triethanolamine, and
(β) citrate,
and
(B) at least one water-soluble polymer that bears at least two ester groups per molecule.

2. The liquid laundry composition according to claim 1, wherein the water-soluble polymer (B) has a biodegradability of at least 40%.

3. The liquid laundry composition according to claim 1 further comprising an enzyme selected from the group consisting of hydrolyses (C).

4. The liquid laundry composition according to claim 1, wherein the composition has a pH value in a range of from 7.5 to 8.5.

5. The liquid laundry composition according to claim 1, wherein the total molar ratio of amino groups in compound (a) to carboxylate groups from compound (β) is in a range of from 1:10 to 10:1.

6. The liquid laundry composition according to claim 1, comprising compound (α) and compound (β) in a range of from 2 to 20% by weight, referring to the total solids content.

7. The liquid laundry composition according to claim 1, wherein said composition has a sodium ion content below 2.0% by weight, referring to the total solids content.

8. The liquid laundry composition according to claim 1, wherein said combination (A) additionally comprises (γ) an aliphatic or cycloaliphatic amine that has a boiling temperature at ambient pressure of 180° C. or more and that does not bear N—CH₂CH(X¹)—OH groups with X1 being selected from the group consisting of hydrogen and C₁-C₂-alkyl.

9. The liquid laundry composition according to claim 1, wherein the water-soluble polymer (B) is selected from the group consisting of polymers that bear
(d) a core that bears one to 3 moieties of the general formula (I), 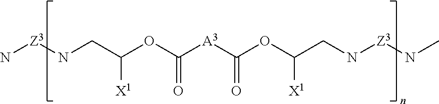
wherein the variables are defined as follows:
Z₃ are different or the same and selected from the group consisting of C₂-C₁₂-alkylene and C₃-C₁₂-cycloalkylene wherein said C₂-C₁₂-alkylene or C₃-C₁₂-cycloalkylene, respectively, may be non-substituted or substituted with one or more O—C₁-C₄-alkyl groups and wherein C₃-C₁₂-cycloalkylene may bear one to three methyl groups,
A₃ are different or same and selected from the group consisting of C₁-C₁₂-alkylene, C₆-arylene, and C₃-C₁₂-cycloalkylene wherein C₂-C₁₂-alkylene and C₃-C₁₂-cycloalkylene may be nonsubstituted or substituted with one or more O—C₁-C₄-alkyl groups or OH groups and wherein C₃-C₁₂-cycloalkylene may bear one to three methyl groups,
or based on citric acid,
X1 is selected from the group consisting of hydrogen and methyl and ethyl and combinations of at least two of the foregoing,
n is in a range of from 1 to 100, and
(e) polyalkylene oxide chains.

10. A method of using the liquid laundry composition according to claim 1, where the method comprises using the liquid laundry composition for laundry care.

11. A method of improving the cleaning performance of a liquid laundry detergent composition, wherein the method comprises adding a combination (A) of chemicals comprising
(α) triethanolamine and
(β) citric acid or a mono- or diammonium salt of citric acid, ammonium being selected from the group consisting of alkylammonium and alkanolammonium,

12. The method according to claim 11, wherein the total molar ratio of N—CH₂CH₂—OH groups of compound (α) to carboxylate groups from compound (β) is in a range of from 1:10 to 10:1.

13. The method according to claim 11, wherein the sodium content of said liquid laundry detergent composition is below 2.0% by weight, referring to the total solids content of said composition.

14. The method according to claim 10, wherein said combination (A) additionally comprises (γ) an aliphatic or cycloaliphatic amine that has a boiling temperature at ambient pressure of 180° C. or more and that does not bear N—CH₂CH(X¹)—OH groups.
